(19) United States
(12) Patent Application Publication
(10) Pub. No.: US 2010/0028564 A1
(43) Pub. Date: Feb. 4, 2010

(54) ANTISTATIC OPTICAL CONSTRUCTIONS HAVING OPTICALLY-TRANSMISSIVE ADHESIVES

(76) Inventors: Ming Cheng, Woodbury, MN (US); Encai Hao, Woodbury, MN (US); Jianhui Xia, Woodbury, MN (US); Albert I. Everaerts, Oakdale, MN (US)

Correspondence Address: 3M INNOVATIVE PROPERTIES COMPANY, PO BOX 33427, ST. PAUL, MN, 55133-3427, US

(21) Appl. No.: 12/181,667

(22) Filed: Jul. 29, 2008

(51) Int. Cl. C09K 19/04; B32B 27/00; B32B 9/00

(52) U.S. Cl. 428/1.1; 428/523; 428/702; 428/697

(57) ABSTRACT

Antistatic optical constructions have optical films that include antistatic layers and optically-transmissive adhesives. A liquid crystal display assembly including the antistatic construction is also disclosed.

### FIELD

The present disclosure relates to optical films that include antistatic layers and optically-transmissive adhesives.

### BACKGROUND

Optically-transmissive pressure sensitive adhesives are used to adhere optical films such as polarizer films to a liquid crystal cell in liquid crystal display (LCD) applications. The polarizer can be any type (e.g., an H-polarizer or a K-polarizer), and can be in direct contact or indirect contact with the adhesive. The external layer of the liquid crystal cell is typically glass. Basic requirements for adhesives used in LCD applications include high optical transmission, low haze, and low birefringence.

The adhesive is typically supplied on a release liner. Residual charge of several hundred volts may be left on the adhesive when the release liner is removed from the adhesive surface. Such a large charge may adversely affect the orientation of liquid crystals when the adhesive is applied to a liquid crystal cell, or the charge may damage electronic circuitry.

Conductive adhesives and antistatic liners have been suggested to reduce or eliminate the residual charge concerns. Some conductive pressure sensitive adhesives are also antistatic because they can readily dissipate charge. However, such conductive adhesives typically include electrically conductive particles, such as carbon fibers, nickel particles, or metal-coated glass beads. Such electrically conductive particles are generally colored and/or large enough to scatter light, and hence are not highly optically transmissive. Antistatic properties can be achieved by applying a conductive layer to the surface of a pressure sensitive adhesive tape backing. For example, antistatic pressure sensitive tapes or sheets may be prepared by using a vanadium pentoxide conductive layer between the adhesive and the tape backing.

Since the adhesive typically is not a good charge carrier, placing the conductive layer between the adhesive and the tape backing does not allow charge on the surface of the adhesive to be discharged quickly and only renders the adhesive somewhat static dissipative; the thicker the adhesive layer, the slower the charge dissipation. Static dissipation has also been achieved by using an antistatic release liner with the adhesive. This can dissipate the charge on the release liner, but it still leaves substantial amount of charge on the adhesive surface.

### SUMMARY

There is a need for antistatic optical constructions that include a compensation film that can quickly dissipate charge, especially residual static charge remaining on the adhesive after an adhesive liner is removed. Further, there is a need for optical constructions that do not adversely affect the orientation of liquid crystals or disrupt the electronic performance when applied to liquid crystal cells.

In one aspect, an antistatic optical construction is provided that includes a compensation film, a conductive layer in contact with the film, and an optically-transmissive adhesive in contact with the conductive layer.

In another aspect, an antistatic optical construction is provided that includes a compensation film, a conductive layer in contact with the film, and an antistatic optically-transmissive adhesive in contact with the conductive layer.

In this application:

“conductive layer” refers to a layer that is electrostatically dissipative;

“(meth)acrylic group” refers to both acrylic and methacrylic groups;

“(meth)acrylate polymer” refers both acrylate, methacrylate polymers and copolymers thereof;

“substituted” refers to substituted by conventional substituents which do not interfere with the desired product, e.g., substituents can be alkyl, alkoxy, aryl, phenyl, halo (F, Cl, Br, I), cyano, nitro, etc.; and

“electrostatically dissipative” refers to an optical construction that has a surface resistance of less than 10¹³ ohms/square.

The provided antistatic optical constructions include compensation films, conductive layers, and adhesives that can be antistatic. These constructions provide high optical transmission, fast charge dissipation, and low surface resistivity when applied to, for example, liquid crystal displays. They also provide protection to electronic circuitry and components that may be present in the liquid crystal devices that include liquid crystal displays.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a side view of an exemplary embodiment of an antistatic optical construction according to the present disclosure.

FIG. 2 is a side view of an exemplary embodiment of an antistatic optical construction according to the present disclosure.

FIG. 3 is a side view of an exemplary embodiment of a liquid crystal display comprising an antistatic optical construction according to the present disclosure of.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

The antistatic constructions include a compensation film. Compensation films intentionally enhance, manipulate, control, maintain, transmit, reflect, refract, absorb, retard, or otherwise alter light or components of light that is impinged upon a surface of the film. Films included in the provided constructions include classes of material that have optical functions, such as polarizers, interference polarizers, reflective polarizers, diffusers, colored optical films, mirrors, louvered optical film, light control films, transparent sheets, brightness enhancement film, and the like. Films for the provided constructions can also include retarder plates such as quarter-wave and half-wave phase retardation optical elements.

The provided optical constructions include a conductive layer in contact with the compensation film that imparts a static dissipative property to the construction. The conductive layer can be provided in the form of a coating, or a layer, in effective amounts to impart the desirable static dissipative property to a construction, particularly at the construction's outermost surface(s). When formed by a coating, the static dissipative layer can have a dry thickness of at least 2 nanometers. The conductive layer can include more than one conductive coating.

A static dissipative property on the surface of a construction can be achieved from a layer that includes a composition having a conductive polymer dispersed in an aqueous or organic solvent. Suitable conductive polymers include, but are not limited to polyanilines, polypyrroles, polythiophenes and combinations thereof. Useful polymers can include, for example, commercially available conductive polymers such as BAYTRON P (available from H.C. Starck, Newton, Mass.). Typically, a conductive polymer can be provided as a dispersion. When applied to a non static-dissipative optical layer, such as a compensation film, the conductive polymers generally are not expected to migrate or penetrate into the optical layer. Alternatively, a conductive layer or coating can include a conductive agent or a static-dissipating agent. Exemplary conductive agents can include dispersions of transparent conductive materials such as indium-tin oxide (ITO), antimony tin oxide (ATO), or other transparent conductive metal oxide known to those of skill in the art.

A binder can optionally be included in the conductive layer composition. Suitable binders are materials that are compatible with the conductive agent or static-dissipating agent (e.g. conductive polymer). Various criteria can be used to characterize suitability of a binder. These include, the binder's ability to form a stable, smooth solution so that lumps and large particles are minimized or eliminated; the binder should not cause precipitates to form; the binder should not reduce the effectiveness of the conductive polymer or agent; and the binder can impart smooth coatability with minimal streaking or reticulation of the conductive layer upon drying. Acrylates, urethanes, epoxides, and combinations thereof are examples of useful optional binders. An acrylic binder can be similar to what has been described in U.S. Pat. No. 6,299,799 (Craig et al.). Another useful binder is a mixed-acrylate melamine-crosslinked film-forming binder composition, as described in U.S. Pat. No. 6,893,731 (Kausch). Embodiments of the invention having a conductive layer can even utilize a solution supplied as CPUD-2 (available from H.C. Starck) which is a composition that includes the conductive polymer BAYTRON P premixed with a urethane binder. Other additives that are consistent and compatible with the conductive layer and compatible with the optical properties of the optical construction can be included in the static-dissipative composition. These include, but are not limited to, coating agents, fillers, dopants, anti-oxidants, stabilizers, and the like.

The conductive layers are in contact with the film. By contact it is meant that the conductive layers are physically touching at least a portion of the film or are in electrical contact with the film. By electrical contact it is meant that the layers are close enough to the film so any electrostatic charge on the film can be transferred to the layer which can then dissipate the charge from the film.

The provided articles include an optically-transmissive adhesive in contact with the layer. By optically-transmissive it is meant that the adhesive transmits at least 75%, at least 80%, at least 85%, or even at least 90% of the total amount of actinic radiation between the wavelengths of about 380 nm to about 760 nm (visible light). The adhesives can include diffusing adhesives that include a light-transmissive adhesive layer containing dispersed colorless light-transmissive particles so as to exhibit a light diffusing characteristic. The diffusing layer can have a transmittance of not lower than 80% of incident intensity and a backscatter of less than 20%. These adhesives are described, for example, in U.S. Pat. No. 6,288,172 (Goetz et al.) and U.S. Pat. No. 6,560,022 (Yano). An adhesive can be considered to be optically clear if it exhibits an optical transmission of at least about 80%, or even higher, and a haze value of below about 10%, or even lower, as measured on a 25 μm thick sample in the manner described below. Pressure sensitive adhesives useful in the present invention include, for example, polyvinyl ethers, and poly (meth)acrylates (including both acrylates and methacrylates).

Any suitable adhesive composition can be used for this invention. In specific embodiments, the adhesive is pressure sensitive and optically-transmissive. Pressure sensitive adhesives (PSAs) are well known to possess properties such as: (1) aggressive and even permanent tack, (2) adherence to a substrate with no more than finger pressure, (3) sufficient ability to hold onto an adherend, and/or (4) sufficient cohesive strength to be removed cleanly from the adherend. Furthermore, the pressure sensitive adhesive can be a single adhesive or a combination of two or more pressure sensitive adhesives.

Useful alkyl acrylates (i.e., acrylic acid alkyl ester monomers) include linear or branched monofunctional acrylates or methacrylates of non-tertiary alkyl alcohols, the alkyl groups of which have from 1 up to 14 and, in particular, from 1 up to 12 carbon atoms. Useful monomers include butyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, isononyl (meth)acrylate and 2-methyl-butyl (meth)acrylate.

In one embodiment, the pressure sensitive adhesive is based on at least one poly(meth)acrylate (e.g., is a (meth)acrylic pressure sensitive adhesive). Poly(meth)acrylate pressure sensitive adhesives are derived from, for example, at least one alkyl (meth)acrylate ester monomer such as, for example, isooctyl acrylate (IOA), isononyl acrylate, 2-methyl-butyl acrylate, 2-ethyl-hexyl acrylate and n-butyl acrylate, isobutyl acrylate, hexyl acrylate, n-octyl acrylate, n-octyl methacrylate, n-nonyl acrylate, isoamyl acrylate, n-decyl acrylate, isodecyl acrylate, isodecyl methacrylate, and dodecyl acrylate; and at least one optional co-monomer component such as, for example, (meth)acrylic acid, N-vinyl pyrrolidone, N-vinylcaprolactam, N,N-dimethyl(meth)acrylamide, N-isopropyl(meth)acrylamide, (meth)acrylamide, isobornyl acrylate, 4-methyl-2-pentyl acrylate, a hydroxyalkyl (meth)acrylate, a vinyl ester, a polystyrene or polymethyl methacrylate macromer, alkyl maleates and alkyl fumarates (based, respectively, on maleic and fumaric acid), or combinations thereof.

In other embodiments, the poly(meth)acrylic pressure sensitive adhesive can be derived from a composition of between about 0 and about 4 weight percent (wt) of hydroxyalkyl (meth)acrylate and between about 100 wt % and about 96 wt % of at least one of isooctyl acrylate, 2-ethyl-hexyl acrylate or n-butyl acrylate. One specific embodiment can be derived from a composition of between about 1 wt % and about 2 wt % hydroxyalkyl (meth)acrylate and between about 99 wt % and about 98 wt % of at least one of isooctyl acrylate, 2-ethylhexyl acrylate or n-butyl acrylate. One specific embodiment can be derived from a composition of about lwt % to about 2 wt % hydroxyalkyl (meth)acrylate, and about 99 wt % to about 98 wt % of a combination of n-butyl acrylate and methyl acrylate.

In some embodiments, the pressure-sensitive adhesive components can be blended to form an optically clear mixture. One or more of the polymeric components can be independently crosslinked or crosslinked with a common cross-linker. Such cross-linkers include thermal cross-linkers which are activated during the drying step of preparing solvent coated adhesives. Such thermal cross-linkers may include multifunctional isocyanates, aziridines and epoxy compounds. In addition, ultraviolet, or “UV”, initiators may be used to cross-link the pressure sensitive adhesive. Such UV initiators may include benzophenones and 4-acryloxybenzophenones.

The pressure sensitive adhesive can be inherently tacky. If desired, tackifiers can be added to a base material to form the pressure sensitive adhesive. Useful tackifiers include, for example, rosin ester resins, aromatic hydrocarbon resins, aliphatic hydrocarbon resins, and terpene resins. In general, light-colored tackifiers selected from hydrogenated rosin esters, terpenes, or aromatic hydrocarbon resins can be used.

Other materials can be added for special purposes, including, for example, oils, plasticizers, antioxidants, UV stabilizers, pigments, curing agents, polymer additives, thickening agents, dyes, chain transfer agents and other additives provided that they do not significantly reduce the optical clarity of the pressure sensitive adhesive. In some embodiments, the plasticizer is provided in an effective amount to facilitate salt dissociation and ion mobility for static dissipation properties in the adhesive; for example, in an amount greater than about 0.01 parts by weight (pbw) based on 100 pbw of acrylic adhesive, optionally an amount greater than about 0. 10 pbw, and in some embodiments in an amount greater than about 1.0 pbw may be used. In some embodiments the plasticizer may be provided in for example, an amount less than about 20 pbw and optionally an amount less than about 10 pbw. In certain embodiments, the plasticizer may facilitate salt dissociation and ion mobility in the adhesive. In some embodiments, the plasticizer is selected from acrylic soluble plasticizers, including phosphate esters, adipate esters, citrate esters, phthalate esters, phenyl ether terminated polyethylene oxide oligomers. In general, non-hydrophilic plasticizers are preferred. Non-hydrophilic plasticizers do not take up significant amounts of moisture from the atmosphere at high humidity and elevated temperatures.

In some embodiments, the optical constructions comprise an antistatic optically-transmissive adhesive in contact with the conductive layer. Both conductive layers and antistatic adhesives can include one or more static-dissipating agents. A static-dissipating agent operates by removing static charge or by preventing build up of such charge. Antistatic agents useful in the provided constructions include non-polymeric and polymeric organic salts. Non-polymeric salts have no repeat units. Generally, the static-dissipating agent comprises an amount less than about 10 wt % of the antistatic pressure sensitive adhesive and optionally an amount less than about 5 wt % of the antistatic PSA. In addition, the static-dissipating agent comprises an amount greater than about 0.5% of the antistatic PSA and optionally an amount greater than about 1.0 wt % of the antistatic PSA.

When combined with a dissociation-enhancing plasticizer, the static-dissipating agent can be used at 4 wt % or less, significantly reducing the cost of the optically-transmissive and reducing any adverse interaction that may exist between the static-dissipating agent and the polarizer. In some preferred embodiments, the static-dissipating salt is a hydrophobic compound. Such hydrophobic static-dissipating compounds tend to reduce the dependence of the performance of the antistatic compound on humidity while improving compatibility with the pressure sensitive adhesive. In some embodiments, both the anion and the cation are organic in that they both include carbon containing groups and are nominally free of metal ions. Generally, the static-dissipating agent is added in an amount that will not adversely affect the desired optical clarity of the antistatic pressure sensitive adhesive. In certain embodiments, the antistatic agent is loaded into the antistatic pressure sensitive adhesive between about 0.05 wt % and about 10 wt %, at any number within that range (e.g., 7 wt %, 1.6 wt %, etc.).

The proper static-dissipating agent for a given adhesive system can be chosen by balancing properties in the cations and anions that make up the antistatic agents to achieve solubility in particular cured adhesive formulations. One specific class of ionic salts as static-dissipating agent in the provided constructions is the class of compounds represented by the general formula:

(R₁)ₜ₋ᵥG⁻[(CH₂)_{q}OR₂]ᵥ X⁻ (I)

wherein each R₁ comprises alkyl, cycloalkyl, aryl, aralkyl, alkaryl, arcycloalkyl, or cycloalkaryl moieties, wherein the moieties may comprise one or more heteroatoms, e.g., nitrogen, oxygen, or sulfur, or may comprise phosphorus, or a halogen (and thus can be fluoro-organic in nature); each R₂ comprises hydrogen or the moieties described above for R₁; G is nitrogen, sulfur or phosphorous; if G is sulfur then t is 3, if G is nitrogen or phosphorous then t is 4; v is an integer of 1 to 3 if G is sulfur, or an integer of 1 to 4 if G is nitrogen or phosphorous; q is an integer of 1 to 4; and X is a weakly coordinating organic anion, such as a fluoro-organic anion. R₁ is typically alkyl, and R₂ is typically hydrogen, alkyl, or aryl (typically, hydrogen or aryl). More detail can be found in U.S. Pat. Publ. No. 2003/0114560 (Jie et al.).

Another specific class of ionic salts that are useful as static-dissipating agents is represented by formula II

(R₃)₄G′⁺X⁻ (II)

where each of the R₃ independently comprises alkyl, alicyclic, aryl, alkaryl or aralkyl moieties, where G′ is N or P, and where X⁻ is a weakly coordinating organic anion. Suitable weakly coordinating organic anions have a conjugate acid that is at least as acidic as a hydrocarbon sulfonic acid (for example, a hydrocarbon sulfonic acid having from 1 to about 20 carbon atoms; such as, an alkane-, aryl-, or alkaryl-sulfonic acid having from 1 to about 20 carbon atoms; and in specific examples, methane or p-toluenesulfonic acid. Generally, the conjugate acid of the organic anion can be a strong acid. For example, the Hammett acidity function, H, of the neat conjugate acid of the anion is less than about −7 (preferably, less than about −10).

Examples of suitable weakly coordinating anions include organic anions such as alkane, aryl, and alkaryl sulfonates; alkane, aryl, alkaryl sulfates; fluorinated and unfluorinated tetraarylborates; and fluoroorganic anions such as fluorinated arylsulfonates, perfluoroalkanesulfonates, cyanoperfluoroalkanesulfonylamides, bis(cyano) perfluoroalkanesulfonylmethides, bis(perfluoroalkanesulfonyl)imides, cyano-bis-(perfluoroalkanesulfonyl)methides, bis(perfluoroalkanesulfonyl)methides, and tris(perfluoroalkanesulfonyl)methides.

Useful ionic salts can be prepared, for example, by known methods or obtained commercially. For example, ionic salts may be prepared by ion exchange or metathesis reactions known in the art. More specifically, a precursor onium salt can be combined with the precursor metal salt or the corresponding acid of a weakly coordinating anion in aqueous solution. Upon combining, the desired product precipitates or can be preferentially extracted into a solvent. The product can be isolated by filtration or by liquid/liquid phase separation, can be washed with water to completely remove byproduct metal halide salt or hydrogen halide, and that can be dried thoroughly under vacuum to remove all volatiles. Similar metathesis reactions can be conducted in organic solvents, rather than in water, and, in this case, the salt byproduct preferentially precipitates, while the products all remain dissolved in the organic solvent (from which they can be isolated using standard techniques). More detail is found in U.S. Pat. No. 6,372,829 (Lamanna et al.).

One embodiment of the present disclosure includes an acrylic based pressure sensitive adhesive with a salt with an organoonium cation from Group IVb to VIIb, preferably from Group Vb to VIb, most preferably from Group Vb, and an organic anion of a strong Bronsted acid wherein the salt or its anions do not migrate to the surface of the acrylic pressure sensitive adhesive to the point where the salts interfere with adhesion to a substrate, for example, a glass substrate associated with an LCD display. Another embodiment of the present disclosure is an acrylic-based PSA with an organic salt with a tetraalkyl ammonium cation and an organic anion of a strong Bronsted acid.

In some embodiments, the antistatic pressure sensitive adhesive can be prepared by forming a PSA and blending it with the antistatic agent to create an antistatic blend. The pressure sensitive adhesive can be formed by blending the pressure sensitive adhesive components, either before polymerization or after polymerization. In some embodiments, the pressure sensitive adhesive components can be further blended with a photoinitiator. Suitable photoinitiators include, for example, IRGACURE 651, from Ciba Specialty Chemicals, Tarrytown, N.Y. The monomers of the pressure sensitive adhesive are first degassed in nitrogen and then irradiated with an appropriate radiation source, e.g., an ultraviolet lamp for a time effective to form a syrup. The syrup generally can have a viscosity of from about 200 centipoise (0.2 Pa-s) to about 3000 centipoise (3.0 Pa-s). The syrup can then be mixed with anti-static agent, crosslinker (multifunctional acrylates to crosslink the syrup), and optional plasticizer. The resulting adhesive composition can be coated on a release liner and further exposed to UV irradiation to yield a fully polymerized, optically clear adhesive.

The antistatic agent can be loaded into the syrup at less than about 10 wt %, and optionally less than about 5 wt %, or even lower. In addition, the antistatic agent can be loaded into the syrup at a weight percentage of greater than about 0.5 wt %, and optionally greater than about 1.0 wt %, or even greater. The antistatic agent and the syrup may be blended using any known means, such as shaking, stirring or mixing. The combination of the syrup and the antistatic agent can be such that the resulting antistatic pressure sensitive adhesive has desirable optical properties upon cure.

In solvent-based pressure sensitive adhesives, the PSA can be coated from solution in an organic solvent and then dried. The solvent-based PSA can be cross-linked during the drying process, or in some cases it can be crosslinked after the drying step. Such cross-linkers include thermal cross-linkers which can be activated during the drying step of preparing solvent coated adhesives. Such thermal cross-linkers may include multifunctional isocyanates, aziridines and epoxy compounds. In addition, UV-triggered cross-linkers may be used. Such UV-triggered cross-linkers may include benzophenones and 4-acryloxybenzophenones.

To further optimize adhesive performance of the optically-transmissive adhesive, adhesion promoting additives, such as silanes and titanates can also be incorporated into the optically clear adhesives of the present disclosure. Such additives can promote adhesion between the adhesive and the substrates, like the glass and cellulose triacetate of an LCD by coupling to the silanol, hydroxyl, or other reactive groups in the substrate. The silanes and titanates can have only alkoxy substitution on the Si or Ti atom connected to an adhesive copolymerizable or interactive group. Alternatively, the silanes and titanates can have both alkyl and alkoxy substitution on the Si or Ti atom connected to an adhesive copolymerizable or interactive group. The adhesive copolymerizable group can generally be an acrylate or methacrylate group, but vinyl and allyl groups can also be used. Alternatively, the silanes or titanates can also react with functional groups in the adhesive, such as an hydroxyalkyl (meth)acrylate. In addition, the silane or titanate can have one or more group providing strong interaction with the adhesive matrix. Examples of this strong interaction include, hydrogen bonding, ionic interaction, and acid-base interaction.

The adhesive composition can be easily coated upon suitable flexible backing materials by any known coating technique to produce adhesive coated sheet materials. The flexible backing materials can be any materials conventionally used as a tape backing, optical film, release liner or any other flexible material. Typical examples of flexible backing materials employed as tape backing that can be useful for the adhesive compositions include those made of paper, plastic films such as polypropylene, polyethylene, polyurethane, polyvinyl chloride, polyester (e.g., polyethylene terephthalate), cellulose acetate, and ethyl cellulose. Some flexible backing can have coatings, for example a release liner can be coated with a low adhesion component, such as silicone. In some embodiments, a second release liner can be laminated to the exposed face of an antistatic adhesive which has been coated on a first release liner. Either the first release liner or the second release liner or both can exhibit a degree of electrostatic dissipation.

The pressure sensitive adhesives of the provided constructions can be applied directly to one or both sides of a conductive layer that is in contact with a compensation film such as a polarizer. The polarizer can include additional layers such as an anti-glare layer, a protective layer, a reflective layer, a phase retardation layer, a wide-angle compensation layer, and a brightness enhancing layer. In some embodiments, the pressure sensitive adhesives can be applied to one or both sides of a liquid crystal cell.

The pressure sensitive adhesives provided constructions can be coated by any variety of known coating techniques such as roll coating, spray coating, knife coating, die coating and the like.

The provided constructions can have desirable antistatic properties. Generally, the surface resistivity of the provided constructions can be less than 1×10¹³ ohms/square, or even less than 1×10¹² ohms/square when measured across the surface of the construction. The surface resistivity of the adhesive layer of the construction can be less than 1×10¹¹ ohms/square, less than 1×10¹⁰ ohms/square, less than 1×10⁹ ohms/square, or even less than 5×10⁸ ohms/square. Additionally, the provided constructions can have antistatic properties in both low and high humidity conditions without resulting in any deterioration in the adhesive itself or in the antistatic properties. The bulk resistivity or electrical resistance of the adhesives disclosed is generally below about 1×10¹¹ ohm-cm as measured through the thickness (also called the “z-direction”). The bulk resistivity or electrical resistance of the adhesives disclosed is generally below about 1×10¹¹ ohm-cm as measured in the plane. As used herein, the plane of the adhesive is the x-y direction or that direction perpendicular to the adhesive thickness. In some embodiments, the electrical resistance (Ohms) in the z- and/or x-y direction is much lower than 1×10¹¹ ohm-cm.

Water absorption into the pressure sensitive adhesive can cause bubbling in the adhesive, change the anti-static performance, or create haze. Organic-soluble salts, particularly hydrophobic, organic-soluble salts, absorb less water, and therefore remain stable in a variety of environments. Similarly, non-hydrophilic plasticizers absorb little or no water, providing an optically, clear and environmentally stable adhesive. Generally it is preferred that the surface resistivity at low relative humidity (R.H.) (23% R.H. at 23° C.) is within a factor of two of the surface resistivity at high humidity (50% R.H. at 20° C.).

Additionally, organic anti-static agents (as discussed above) are available and can be stable in antistatic PSAs of the provided constructions. Inorganic and metal cation salts can tend to precipitate and phase separate from the pressure sensitive adhesive matrix in certain conditions. This is especially true in low humidity or in the absence of solubilizing components, such as polyethylene oxide containing plasticizers and metal ion chelating plasticizers or additives. For this reason, organic cations and anions are often preferred.

The antistatic pressure sensitive adhesive of the present disclosure exhibits desirable optical properties, for example the disclosed adhesives have a higher luminous transmission and lower haze than a selected substrate. Therefore, a provided PSA construction can have substantially the same luminous transmission and haze as the backing alone. In other embodiments, the PSA can have a lower opacity than the substrate, for example less than 1%, and in specific embodiments less than 0.6%. In a multiple layered article, each layer generally can contribute to a decrease in luminous transmission.

The antistatic pressure sensitive adhesive of the present invention, when added to a multilayered optical construction, will generally not reduce optical properties further. For example, a sheet of polyethylene terephthalate 25 μm thick having a luminous transmission of greater than 88% and a haze of less than 5%, together with a provided PSA upon this polyethylene terephthalate backing can also have a luminous transmission of greater than 88% and a haze of less than 5%. In such embodiments, the adhesive can have a luminous transmission of greater than 88%, e.g., 89% or higher. In certain embodiments, the haze can be less than 4%, and in some embodiments the haze is less than 2%. The opacity of the antistatic pressure sensitive adhesive of some embodiments can generally be less than about 1%, more preferably below about 0.6%. These optical features can be measured using a microscope slide measured without, and then with, the adhesive laminated to the slide and comparing the results.

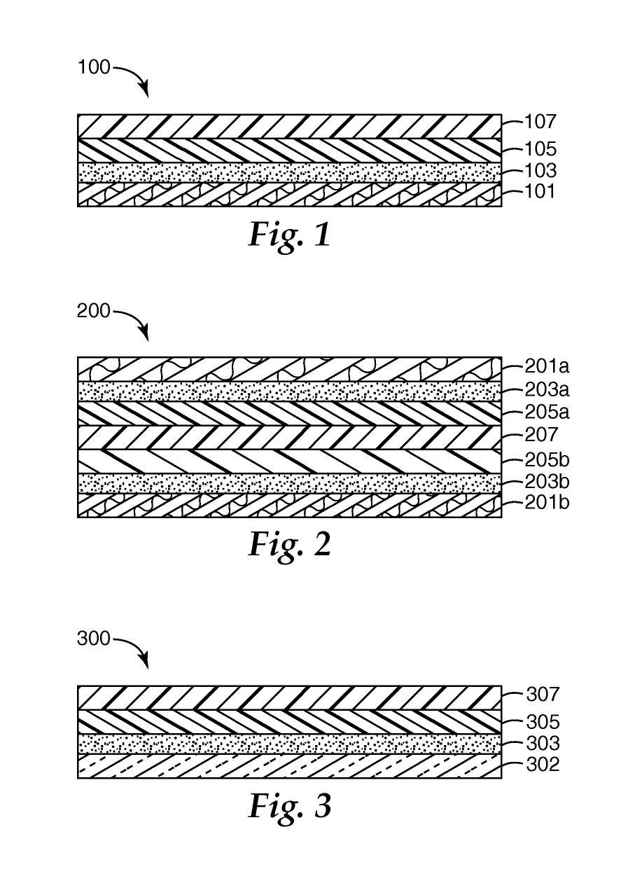

FIG. 1 is an illustration of an embodiment of the provided constructions that includes a compensation film, a conductive layer, and an adhesive on a release liner. The illustrated embodiment 100 includes antistatic optically-transmissive adhesive 103 on top of release liner 101. Adhesive 103 is in contact with conductive layer 105 and conductive layer 105 is in contact with optical compensation film 107.

FIG. 2 is an illustration of another embodiment of the provided construction. The illustrated embodiment 200 includes two antistatic optically-transmissive adhesives 203a and 203b that are in contact with two conductive layers 205a and 205b respectively. The conductive layers 205a and 205b are coated on opposite sites of optical compensation film 207. Each of the adhesives 203a and 203b are also in contact with release liners 201a and 201b respectively.

FIG. 3 is an illustration of an embodiment of a liquid crystal display comprising a provided construction. This embodiment 300 includes antistatic optically-transmissive adhesive 303 in contact with conductive layer 305. Conductive layer 305 is itself in contact with compensation film 307. The adhesive, layer and film are in contact with LCD 302 as shown.

Objects and advantages of this invention are further illustrated by the following examples, but the particular materials and amounts thereof recited in these examples, as well as other conditions and details, should not be construed to unduly limit this invention.

### EXAMPLES

Table of Abbreviations

| Abbreviation | |
|---|---|
| or Trade | |
| Designation | Description |
| BAYTRON | 1.3 weight percent (wt %) in water, the conductive polymer |
| P | aqueous dispersion, available from H.C. Starck, Newton, |
| | MA |
| TOMADOL | ethoxylated C12-C15 alcohols wetting agent, available from |
| 25-9 | Tomah Products, Inc, Allentown, PA. |
| WB 50 | a water-soluble sulfopolyester polymer at about 20 wt % |
| RESIN | solids, was prepared according to Example 5 (Polymer D) |
| | of U.S. Pat. No. 5,427,835. The T_{g} of WB 50 is reported |
| | to be 70.3° C. by differential scanning calorimetry (DSC). |
| XR-5577 | 40 wt % in water, a carbodiimide crosslinker, available |
| | from Stahl Chemicals, Waldenburg, Germany |
| ZEONOR | cyclo olefin polymer film, 30.5 μm thick and 30.5 cm wide, |
| FILM | available from Zeon Chemicals, Louisville, KY. was corona |
| | treated before lamination. |
| VAZO 67 | 2,2′-azobis(2-methylbutyronitrile), a thermal initiator |
| | commercial available from E.I. doPont de Nemours & |
| | Co.; Wilmington, DE. |
| V-601 | dimethyl 2,2′-azobisisobutyrate, a thermal initiator |
| | commercially available from Wako Specialty Chemicals |

### Test Methods:

### Antistatic Efficiency Measurements

Static charge decay time was measured using an Electro-Tech Systems, Inc. Model 406C (available from Electro-Tech, Glenside, Pa.) static decay meter by charging the sample to ±5 kV and measuring the time required for the static charge to decay to 10% of its initial value. Film samples approximately five inches (12.7 cm) on a side were cut and mounted between the meter electrodes using magnets. Static charge decay tests were performed on three parallel film samples, reporting the average decay time.

Surface resistance measurements were performed using a PROSTAT (Bensenville, Ill.) PRS-801 resistance system equipped with a PRF-911 concentric ring fixture. Output values in ohms were converted to ohms/square by multiplying the measured values by 10 according to the documentation supplied with the instrument. Surface resistance and static charge decay measurements were made at ambient laboratory humidity of 30-40%. Three measurements were taken on single film substrates, reporting the average measurement.

### Optical Property Measurements

The haze (% H) and transmission (% T) were measured using a Haze-Gard Plus (available from BYK-Gardner USA, Columbia, Md.).

### 180° Peel Adhesion

This peel adhesion test is similar to the test method described in ASTM D 3330-90, substituting a glass substrate for the stainless steel substrate described in the test. Adhesive coatings on polyester film were cut into 1.27 cm by 15 cm strips. Each strip was then adhered to a 10 cm by 20 cm clean, solvent washed glass coupon using a 2 kg roller passed once over the strip. The bonded assembly dwelled at room temperature for about one minute and was tested for 180° peel adhesion using an IMASS SP-2000 Peel Tester (available from IMASS Inc., Accord, Mass.). Two samples were tested; the reported peel adhesion value is an average of the peel adhesion value from each of the two samples. Additionally, samples were allowed to dwell at constant temperature and humidity conditions for 24 hours and then were tested for 180° peel adhesion.

### Adhesive Anchorage Test

This procedure was used to measure the force necessary to remove a PSA coating from its backing. PSA samples were cut into 1 inch (2.54 cm) wide and 8 inches (20.3 cm) long strips, and laminated onto anodized aluminum plates with a 4.5 lb roller. These laminates were then dwelled for at least 20 minutes at 23° C./50% RH. Peel adhesion test was conducted on an IMASS SP-2000 Peel Tester. The peel speed was 12 inch/minute (30.5 cm/min), and peel angle was 180 degree. The force was reported in Newtons.

### Preparation of Antistatic Sulfopolyester PEDOT Primer Formulation

0.8 g of DMSO was added in 16 g of PEDOT/PSS (poly(3,4-ethylenedioxythiophene))/polystyrene sulfonate, available from H.C. Stark, Richmond, Va. as a solution (1.3 wt %). The solution was stirred overnight before using. 7.65 g of WB50 solution (20 wt %), 34 g of DI water, 0.5 g of XR5577 (40 wt % in water), and 0.38 g of TOMADOL 25-9 (10 wt %) were mixed together, then 7.0 g of DMSO-modified PEDOT solution was added and the mixture was further stirred for 30 min.

Preparation of Polyolefin Film with Antistatic PEDOT Primer

The antistatic PEDOT primer solution was applied on ZEONOR film using #4 rods, and then the films were dried at 70° C. for 3 min. The resulting films were coated or laminated with optically clear adhesives.

### Preparation of Pressure Sensitive Adhesive-1 (PSA-1)

A 1.0 Liter bottle was charged with VAZO 67 (0.2 g), n-butyl acrylate (BA) (88 g), methyl acrylate (MA) (10 g), 2-hydroxy ethyl acrylate (2HEA) (2 g), and ethyl acetate (EtOAc) (150 g). The solution was deairated with nitrogen for 10 min and was then heated at 58° C. in a water bath for 24 h. Additional EtOAc (210 g) and toluene (40 g) were added to yield a viscous solution at 20 wt % solids.

### Preparation of Anti-Static Pressure Sensitive Adhesive-1 (ASPSA-1)

The adhesive was prepared using the same procedure as PSA-1, except an anti-static agent, [Bu₃N⁺(Me)] [⁻N(SO₂CF₃)₂] (1.5 wt % of the dried PSA-1), was added to the diluted solution at 20%.

### Preparation of Pressure Sensitive Adhesive 2 (PSA-2)

A 1.0 Liter bottle was charged with V-601 (0.2 g), IOA (93 g), acrylamide (7 g), ethyl acetate (EtOAc) (119.3 g), and methanol (13.26 g). The solution was deaerated with nitrogen for 10 min and was then heated at 55° C. in a water bath for 16 h, followed by heating at 65° C. for 18 h. Additional EtOAc (70.78 g), toluene (88.66 g), and methanol (24.67 g) were added to yield a viscous solution at 24% solids.

### Preparation of Anti-Static Pressure Sensitive Adhesive-2 (ASPSA-2)

The adhesive was prepared using the same procedure as PSA-2, except an anti-static agent, [Bu₃N⁺(Me)] [⁻N(SO₂CF₃)₂] (1.5 wt % of the dried PSA-2), was added to the diluted solution at 24%.

### Preparation of Pressure Sensitive Adhesive-3 (PSA-3)

A monomer premix was prepared using 2-ethylhexyl acrylate (2-EHA) (95 parts), 2-hydroxy ethyl acrylate (2HEA) (5 parts), and 2,2-dimethoxy-2-phenylacetophenone photo-initiator (0.04 parts) (IRGACURE 651, available from Ciba Specialty Chemicals, Tarrytown, N.Y.). This mixture was partially polymerized under a nitrogen-rich atmosphere by exposure to ultraviolet radiation to provide a coatable syrup having a viscosity of about 2,000 cps. Then 1,6-hexanediol diacrylate (HDDA) (0.05 part) and additional IRGACURE 651 (0.11 part) were added to the syrup and it was then knife coated in-between two silicone-treated PET release liners at a thickness of 0.001 inch (25.4 μm). The resulting composite was then exposed to low intensity ultraviolet radiation (a total energy of 1,200 mJ/cm²) having a spectral output from 300-400 nm with at maximum at 351 nm.

### Preparation of Anti-Static Pressure Sensitive Adhesive 3 (ASPSA-3)

The adhesive was prepared using the same procedure as PSA-2, except an anti-static agent, [Bu₃N⁺(Me)] [⁻N(SO₂CF₃)₂] (1.5 wt % of the dried PSA-3), was added to the monomer mixture prior to the ultraviolet radiation.

### Pressure Sensitive Adhesive (PSA) Coating

PSA was applied to anti-static coated ZEONOR compensation film either through direct coating or lamination.
Direct coating: an acrylic PSA solution was directly coated on the film and dried at 70° C. for 10 min to a final PSA thickness of 1.0 mil (25.4 μm).
Lamination: the acrylic PSA solution was coated on a release liner and dried at 70° C. for 10 min to a final PSA thickness of 1.0 mil (25.4 μm). The dried PSA was then laminated to the surface of the compensation film.

### Comparative Example 1

A laminate of ZEONOR polyolefin film and ASPSA-1 was cut into a 100 mm×150 mm piece and mounted onto a thick glass plate (CORNING EAGLE 2000, available from Corning, Ithaca, N.Y.). The surface resistance and charge decay were measured on the polyolefin film side, the glass side, and the optically clear adhesive side.

### Example 1

A laminate of ZEONOR polyolefin film which had been primed with the antistatic sulfopolyester/PEDOT primer solution described above and directly coated with an optically clear adhesive PSA-1 was mounted on a thick glass plate as in Comparative Example 1.

### Example 2

A laminate of ZEONOR polyolefin film which had been primed with the antistatic PEDOT primer solution described above was directly coated with an antistatic optically clear adhesive ASPSA-1 and then mounted on a thick glass plate as in Comparative Example 1.

TABLE 1
Electrostatic Dissipation of Comparative Example 1 and Examples 1-2

| | Surface Resistivity | | | | | |
|---|---|---|---|---|---|---|
| | (ohms/square) | | | Charge Decay Time (sec) | | |
| Sample | Film Side | Glass Side | Adhesive | Film Side | Glass Side | Adhesive |
| Comparative | 3.8 × 10¹³ | 1.2 × 10¹⁴ | 1.9 × 10¹¹ | 0.19 | 0.23 | 0.28 |
| Example 1 | | | | | | |
| Example 1 | 5.8 × 10¹³ | 1.6 × 10¹³ | 8.7 × 10⁹ | 0.01 | 0.01 | 0.01 |
| Example 2 | 2.3 × 10¹³ | 1.6 × 10¹⁴ | 1.7 × 10⁸ | 0.01 | 0.01 | 0.01 |

TABLE 2
Optical Property Measurements of Comparative
Example 1 and Examples 1-2

| Sample | Transmittance (%) | Haze (%) |
|---|---|---|
| Comparative Example 1 | 92.0 | 0.4 |
| Example 1 | 91.5 | 0.6 |
| Example 2 | 91.3 | 0.6 |

### Example 3

### Preparation of Antistatic Sulfopolyester/ATO Primer Formulation

30.6 g of SP-2 (20 wt %), 124.6 g of DI water, γ-glycidoxypropyl-trimethoxysilane (5% wt in DI water), and 1.1 g of TOMADOL 25-9 (10 wt %) were mixed together. Then 45.8 g of 30 nm antimony tin oxide ATO nanoparticle dispersion (30 wt % in water, Advanced Nano Products Co. Ltd.) was added, the mixture was further stirred for 30 min.

Preparation of Polyolefin Film with Antistatic Sulfopolyester/ATO Primer

The antistatic sulfopolyester/ATO primer solution was applied on ZEONOR film using #4 rods, and then the films were dried at 70° C. for 3 min. The resulting films were coated or laminated with optically clear adhesives.

A laminate of ZEONOR polyolefin film which had been primed with the antistatic sulfopolyester/ATO primer solution described above and directly coated with an antistatic optically clear adhesive. The antistatic performance of the adhesive was measured and is shown in Table 4.

TABLE 4
Electrostatic Dissipation of Example 3

| | Surface resistance | Charge Decay |
|---|---|---|
| | (ohms/square) | (Second) |
| ASPSA-1 | 1.9 × 10¹¹ | 0.2 |
| Zeonor/ATO Primer | 1.5 × 10⁹ | 0.01 |
| Zeonor/ATO Primer/ASPSA-1 | 2.0 × 10⁹ | 0.01 |

### Example 4

The sulfopolyester/PEDOT primer was applied on ZEONOR film or other optical substrates such as PET as described above. Different PSAs and ASPSAs were directly coated on the primer. The surface resistance of the resulting constructions is shown in Table 5.

TABLE 5
Electrostatic Properties of PSAs and ASPSAs

| | | Surface Resistance |
|---|---|---|
| PSA | Substrates | (ohms/square) |
| PSA-2 | Release Liner | 2.2 × 10¹³ |
| | AS Primer | 4.5 × 10¹¹ |
| ASPSA-2 | Release Liner | 1.1 × 10¹¹ |
| | AS Primer | 9.0 × 10⁸ |
| PSA-3 | Release Liner | 4.5 × 10¹³ |
| | AS Primer | 3.6 × 10¹¹ |
| ASPSA-3 | Release Liner | 2.2 × 10¹² |
| | AS Primer | 1.2 × 10⁹ |

* AS Primer: Surface Resistance = 1.5 × 10⁶ ohms/square

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All cited references are herein incorporated by reference in their entirety.

What is claimed is:

1. An optical construction comprising:
a compensation film;
a conductive layer in contact with the compensation film; and
an optically-transmissive adhesive in contact with the conductive layer.

2. A construction according to claim 1 wherein the compensation film comprises an H-type polarizer, a K-type polarizer, a retarder plate, or a combination thereof.

3. A construction according to claim 1 wherein the compensation film comprises a polyolefin.

4. A construction according to claim 1 wherein the conductive layer comprises an organic conductor.

5. A construction according to claim 4 wherein the organic conductor is selected from polyanilines, polypyrroles, polythiophenes and combinations thereof.

6. A construction according to claim 1 wherein the conductive layer comprises a transparent metal oxide.

7. A construction according to claim 6 wherein the transparent metal oxide comprises antimony tin oxide.

8. A construction according to claim 1 wherein the optically-transmissive adhesive is optically clear.

9. A construction according to claim 8 wherein the adhesive transmits at least 85% of actinic radiation at wavelengths between about 380 nm and about 760 nm.

10. A construction according to claim 1 wherein the adhesive has a surface resistivity of less than about 10¹⁰ ohms/square.

11. A construction according to claim 1 wherein the adhesive has a charge decay time of less than 0.05 seconds.

12. A liquid crystal display comprising a construction according to claim 1.

13. An antistatic construction comprising:
a compensation film;
a conductive layer in contact with the compensation film; and
an antistatic optically-transmissive adhesive in contact with the conductive layer.

14. A construction according to claim 13 wherein the compensation film comprises an H-type polarizer, a K-type polarizer, a retarder plate, or a combination thereof.

15. A construction according to claim 13 wherein the conductive layer comprises an organic static-dissipating agent.

16. A construction according to claim 13 wherein the conductive layer comprises a transparent metal oxide.

17. A construction according to claim 13 wherein the optically-transmissive adhesive comprises an acrylate copolymer.

18. A construction according to claim 13 wherein the static-dissipating agent comprises an ionic salt.

19. A construction according to claim 18 wherein the ionic salt comprises an ion selected from sulfonamide, imide, methide, borate, an onium cation from Group IVb to VIIb, Group Vb to VIb, ammonium, phosphonium, sulfonium, lithium, sodium, and potassium.

20. A construction according to claim 18 wherein the ionic salt has the formula:
(R₁)ₜ₋ᵥG⁻[(CH₂)_{q}OR₂]ᵥ X⁻ (I)
wherein each R₁ comprises alkyl, cycloalkyl, aryl, aralkyl, alkaryl, arcycloalkyl, or cycloalkaryl moieties, wherein the moieties comprise one or more heteroatoms selected from nitrogen, oxygen, sulfur, phosphorus, or a halogen; each R₂ comprises hydrogen or the moieties described above for R₁; G is selected from nitrogen, sulfur and phosphorous; if G is sulfur then t is 3, if G is nitrogen or phosphorous then t is 4; v is an integer of 1 to 3 if G is sulfur, or an integer of 1 to 4 if G is nitrogen or phosphorous; q is an integer of 1 to 4; and X is a weakly coordinating organic anion.

21. A construction according to claim 20 wherein R₁ comprises alkyl, and R₂ comprises hydrogen, alkyl, aryl, or combinations thereof.

22. A construction according to claim 18 wherein the ionic salt has the formula
(R₃)₄G′⁺ X⁻ (II)
where each R₃ independently comprises alkyl, alicyclic, aryl, alkaryl, or aralkyl moieties, where G′ is N or P, and where X⁻ is a weakly coordinating organic anion.

23. A construction according to claim 22 wherein the weakly coordinating organic anion comprises an alkane, aryl, or alkaryl sulfonic acid having from 1 to about 20 carbon atoms.

24. A construction according to claim 23 wherein the sulfonic acid is selected from methane sulfonic acid, p-toluene sulfonic acid, and combinations thereof.

25. A construction according to claim 13 wherein the surface resistivity of the adhesive is less than about 5×10⁸ ohms/square.

26. A liquid crystal display comprising a construction according to claim 13.
